(19) United States
(12) Patent Application Publication
(10) Pub. No.: US 2007/0195377 A1
(43) Pub. Date: Aug. 23, 2007

(54) Printing device and printing method

(76) Inventors: Seiji Aiso, Shiojiri-shi (JP); Kanji Fukasawa, Matsumoto-shi (JP); Ayahiro Nakajima, Matsumoto-shi (JP)

Correspondence Address: MARTINE PENILLA & GENCARELLA, LLP, 710 LAKEWAY DRIVE, SUITE 200, SUNNYVALE, CA, 94085, US

(21) Appl. No.: 11/707,395

(22) Filed: Feb. 15, 2007

(30) Foreign Application Priority Data
Feb. 20, 2006 (JP) 2006-42030

(51) Int. Cl. H04N 1/40

(52) U.S. Cl. 358/448

(57) ABSTRACT

When image data is input from a memory card or the like, the printing device prints an order sheet that includes a recipient specification field showing reduced images of the input image data and enabling recipients for the image data to be specified, and a sorting method specification field for specifying the sorting method for individual recipients. Using this order sheet, the user specifies the sorting method of the image data and the image data for individual recipients, and scans the order sheet with a scanner. The printing device then prints the specified image data for the individual recipients, in accordance with the sorting method specified on the order sheet. It is possible thereby to easily distribute images to individual recipients during printing of the image data using an order sheet.

### CROSS-REFERENCE TO RELATED APPLICATIONS

The present application claims the priority based on Japanese Patent Application No. 2006-42030 filed on Feb. 20, 2006, the disclosure of which is hereby incorporated by reference in its entirety.

### BACKGROUND

1. Technical Field

The present invention relates to a technology for specifying image data for printing, using an order sheet.

2. Related Art

Printing devices known as “multifunction printers” which incorporate a scanner and memory card reader have become widespread in recent years. Some printing devices of this kind have a function for printing, in the form of an order sheet, a list of image data input from a memory card or the like. Using a writing implement to fill in marking fields provided on the order sheet, a user can reserve the image data for printing. The printing device then scans the order sheet with the scanner, analyzes the marking field provided for each set of image data to determine whether a marking has been made, and then performs printing for those sets of marked image data.

In relation to technology of this kind, JP-A-2004-34584 discloses a printing device that prints a list of the image data as an index print mode. The index print mode allows specification of the number of copies to be printed for each set of image data.

While the printing device disclosed in the cited publication allows specification the number of copies to be printed for each set of image data to be specified. In the event that the printed images are to be distributed to multiple recipients, it was necessary to manually sort the printed images intended for distribution to each recipient. This process was extremely laborious.

### SUMMARY

An advantage of some aspects of the invention is to afford ease of distribution of images to each of multiple recipients, during printing of image data using an order sheet.

In an aspect of the invention, a printing device for printing image data comprises an input unit that inputs multiple sets of image data; an order sheet printing unit that prints an order sheet wherein there are laid out a list of the input image data, and a marking field having differentiatable elements for each individual set of the image data; a scanning unit that scans the order sheet; an analyzing unit that analyzes the scanned order sheet and specifies the elements marked by the marking fields; and an image data printing unit that groups and prints the image data for each of the marked elements, on the basis of the results of the analysis of the scanned order sheet.

According to the printing device, image data is printed for each element specified by the user, using the order sheet. This eliminates the need for a manual operation to sort the printed images, and makes it possible to easily distribute the printed images to the recipients corresponding to the elements.

Besides the aspect of the printing device described above, the invention could also take the aspect of a printing method for printing image data by a printing device equipped with a scanner; or a computer program for printing image data by a computer having a printing device and a scanner connected thereto. The computer program may be recorded on a computer-readable recording medium. Media of various kinds, such as a flexible disk, CD-ROM, DVD-ROM, magnetooptical disk, memory card, or hard disk, may be used as recording media. Additionally, the computer program for printing image data may be stored on a server, and utilized over a network.

These and other objects, features, aspects, and advantages of the invention will become more apparent from the following detailed description of the preferred embodiments with the accompanying drawings.

### BRIEF DESCRIPTION OF THE DRAWINGS

FIG. 1 is an illustration of the configuration of a printing device.

FIG. 2 is an illustration of the internal configuration of the printing device.

FIG. 3 is a flowchart of the printing process for individual recipients.

FIG. 4 is an illustration depicting an example of an order sheet.

FIG. 5 is an illustration depicting the form of a second order sheet.

FIG. 6 is an illustration depicting the form of a third order sheet.

FIG. 7 is an illustration depicting an example of filling in the third order sheet.

FIG. 8 is an illustration depicting an example of a confirmation/correction order sheet.

### DESCRIPTION OF THE PREFERRED EMBODIMENTS

In order to elucidate further the operation and working effects of the present invention described hereinabove, the embodiments of the invention will be discussed below in the following order.

A. Configuration of Printing Device:

B. Printing Process for Individual Recipients:

C. Other Forms of the Order Sheet:

D. Modifications:

E. Other Aspects:

A. Configuration of Printing Device:

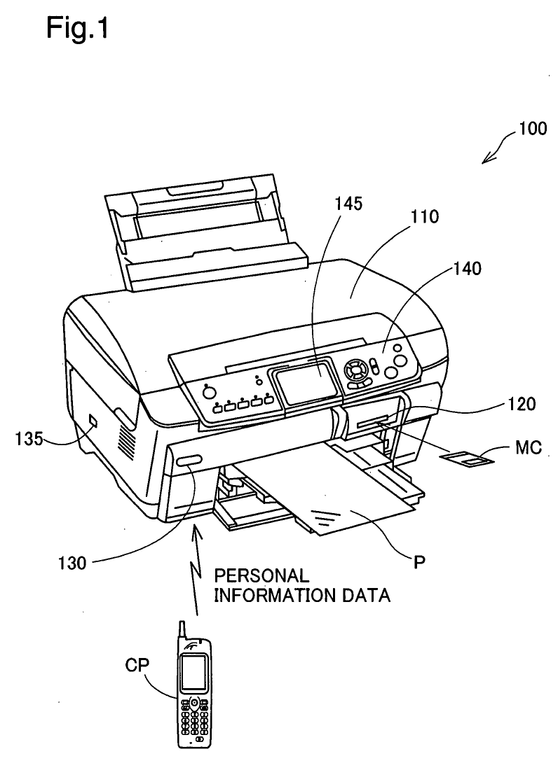

FIG. 1 is an illustration of the configuration of the printing device 100 according to an embodiment. The printing device 100 is a multifunction type device equipped with a scanner 110 for optical scanning of images; a memory card slot 120 for insertion of a memory card MC having image data recorded thereon; an infrared interface 130 for infrared communication with a mobile phone CP in accordance with IrDA (Infrared Data Association) standards; and a network interface 135 for connecting the printing device 100 to a network. The printing device 100 is capable of printing images scanned by the scanner 110, images read from the memory card MC, or images received from a computer connected by a USB interface (not shown).

The printing device 100 is also furnished with a control panel 140 for performing various operations relating to printing. A liquid crystal monitor 145 is located in the center of the control panel 140. This liquid crystal monitor 145 displays image data read from the memory card MC etc., and displays a GUI (Graphical User Interface) when utilizing various functions of the printing device 100.

The printing device 100 can acquire individual information data from the mobile phone CP via the infrared interface 130. This individual information data is data of vCard format based on the electronic business card standard; it includes name, mail address, physical address, phone number, a facial image.

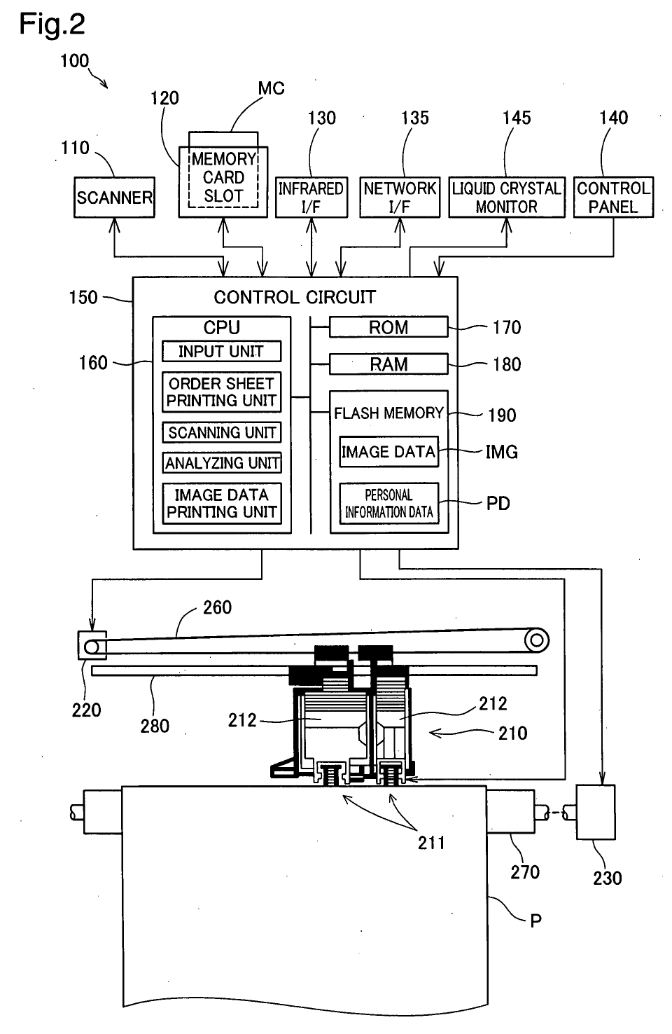

FIG. 2 is an illustration of the internal configuration of the printing device 100. As illustrated, the printing device 100 is provided, by way of the mechanism for carrying out printing, with a carriage 210 having ink cartridges 212 on board; a carriage motor 220 for driving the carriage 210 in the main scanning direction; and a paper feed motor 230 for transporting printing paper P in the sub-scanning direction.

The carriage 210 is provided with a total of six ink cartridges 211 for inks used to represent the colors cyan, magenta, yellow, black, light cyan, and light magenta. The ink cartridges 212 containing these inks are installed on the carriage 210, and the ink delivered from the ink cartridges 212 to an ink head 211 is ejected onto the printing paper P by means of actuating piezo elements, not shown.

The carriage 210 is slidably held on a slide rail 280 positioned parallel to the axial direction of a platen 270. The carriage motor 220 turns a drive belt 260 in response to an instruction from a control circuit 150, thereby reciprocating the carriage 210 parallel to the axial direction of the platen 270, i.e. in the main scanning direction.

By rotating the platen 270, the paper feed motor 230 transports the printing paper P perpendicular to the axial direction of the platen 270. That is, the paper feed motor 230 can move the paper in the sub-scanning direction relative to the carriage 210.

The printing device 100 is equipped with the control circuit 150 for controlling operation of the ink head 211, the carriage motor 220, and the paper feed motor 230 mentioned above. The control circuit 150 is connected to the scanner 110, the memory card slot 120, the infrared interface 130, the network interface 135, the control panel 140, and the liquid crystal monitor 145 shown in FIG. 1.

The control circuit 150 comprises a CPU 160, a ROM 170, a RAM 180, and a flash memory 190. A control program for controlling the operations of the printing device 100 is stored in the ROM 170. The CPU 160 loads the control program into the RAM 180 and executes it in order to carry out various processes, to be discussed later. The CPU 160 corresponds to the “input unit,” “order sheet printing unit,” “scanning unit,” “analyzing unit” and “image data printing unit” herein.

The flash memory 190 is a storage device for storing image data IMG acquired from the memory card MC etc., as well as individual information data acquired from the mobile phone CP via the infrared interface 130. While flash memory is provided as the storage device in the present embodiment, a hard disk drive or other storage device could be provided instead. Individual information data PD may be acquired not only from the mobile phone CP, but also from a computer connected to the printing device 100; or input by the user from the control panel 140.

B. Printing Process for Individual Recipients:

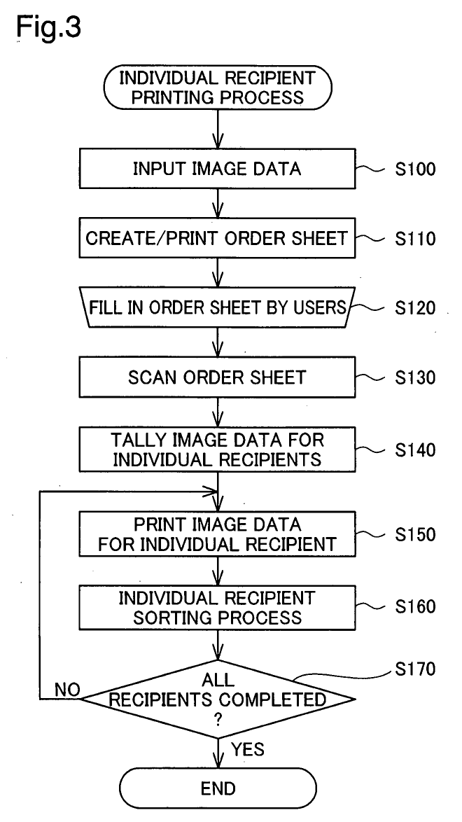

FIG. 3 is a flowchart of the printing process for individual recipients, executed by the CPU 160 on the basis of the control program stored in the ROM 170. This process is executed in the event that the function of printing image data for individual recipients has been selected the user from the GUI displayed on the liquid crystal monitor 145.

When the process is executed, the CPU 160 first inputs multiple sets of image data from the memory card MC or the flash memory 190 (Step S100). The input source for the image data can be set at the discretion of the user, through operation of the GUI displayed on the liquid crystal monitor 145.

The CPU 160 next generates an order sheet on which reduced images of the input image data are arranged, and prints it out (Step S110).

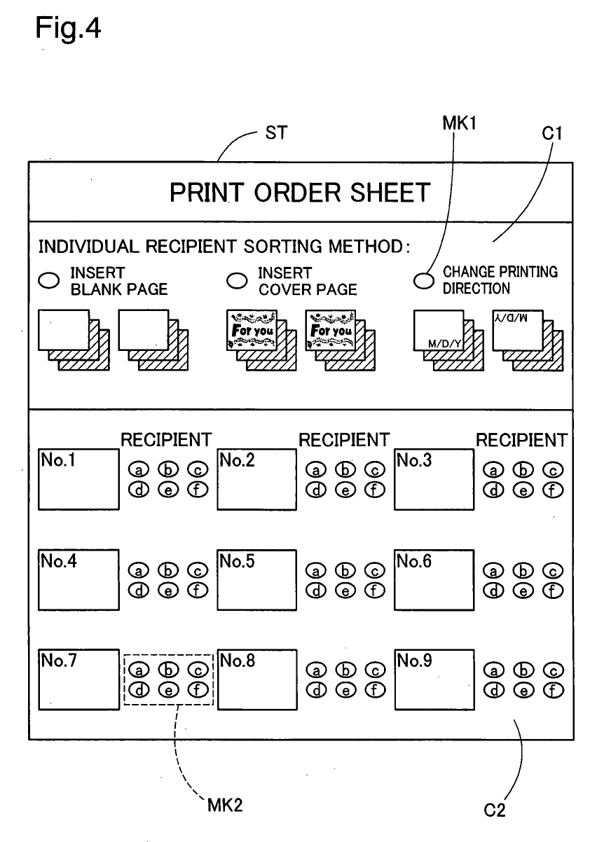

FIG. 4 is an illustration depicting an example of the order sheet ST generated in Step S110. This order sheet ST has a sorting method specification field C1 for specifying a sorting method for printing image data for individual recipients; and a recipient specification field C2 for specifying the recipients for each set of image data. This recipient specification field C2 corresponds to the “marking field having two or more differentiatable elements” herein.

In the sorting method specification field C1 contains marking fields MK1 permitting specification of any of three kinds of sorting methods, namely “insert a blank sheet,” “insert a cover sheet,” and “change print direction.” Using a writing implement to fill in the three marking fields provided in the sorting method specification field C1, the user can specify the sorting method during printing of the image data.

Reduced images of the image data input in Step S100 are positioned in the recipient specification field C2 (the areas labeled “No. 1” to “No. 9” in the drawing), and to the right side of each set of image data there is provided a marking field MK2 for specifying which recipients the image data will be distributed to. In the illustrated order sheet, it is possible to specify up to six recipients (a) to (f). Using a writing implement to mark the marking field MK2, the user can specify recipients for each set of image data. Where a marking field MK2 has not been filled in at all, the corresponding image data will not be printed.

The discussion now refers back to FIG. 3. Once the order sheet ST has been printed through Step S110, the user specifies the sorting method for the printed images and the recipients for each set of image data, by marking the appropriate marking fields of the printed order sheet ST (Step S120).

After completing filling in of the order sheet ST, the user places the order sheet ST on the scanner 110 and performs a scan start operation of the order sheet ST using the control panel 140. When the CPU 160 detects the scan start s operation by the user, it scans the order sheet ST using the scanner 110 (Step S130).

Once the order sheet ST has been scanned in Step S130, the CPU 160 now analyzes the marking fields that were marked in the recipient specification field C2, and tallies which image data to group and print for each recipient (in the case shown in FIG. 4, (a) to (f)) (Step S140).

Once tallying of image data for each recipient has been completed, the CPU 160 prints in succession the image data corresponding to the first recipient (Step S150). When printing of data for this recipient has been completed, before printing the image data corresponding to the next recipient, sorting is carried out for the individual recipient by the method specified in the sorting method specification field C1 (Step S160). Specifically, where “insert a blank sheet” has been specified in the marking field MK1 of the sorting method specification field C1, one blank sheet of paper is output; or where “insert a cover sheet” has been specified, one cover sheet displaying a prescribed image is printed. Where “change print direction” has been specified, the printing direction of the next set of image data to be printed for the recipient is changed.

In Step S150, in response to a setting made by the user, the shooting time of the image data can be combined with the image data and printed out. By so doing, in the event that the printing direction has been changed, the printing direction of both the shooting time and the image data will be changed for printout, so it will be possible to easily verify that image data has been printed for each individual recipient. In Step S160 discussed above, during printout of the cover page, an image for display on the cover page can be selected from the GUI on the liquid crystal monitor 145.

Once the process of sorting for individual recipients has been completed, the CPU 160 then decides whether printing of image data has been completed for all recipients (Step S170). As a result, if printing has been completed for all recipients, the series of printing processes for individual recipients is terminated, or if not completed, the process returns to Step S150 described previously and image data is printed for the next recipient.

According to the printing device 100 of the present embodiment discussed above, image data to be printed for individual recipients can be specified easily through the use of the order sheet ST. During printing of image data for different recipients, a blank sheet or cover sheet can be inserted, or the printing direction changed, depending on the sorting method specified in the order sheet ST, thus eliminating the need for the user to manually sort the printed image data, and making it possible for the printed image data to be easily distributed to individual recipients.

C. Other Forms of the Order Sheet:

The order sheet ST in the embodiment described above may take a number of other forms besides the form shown in FIG. 4. Other forms of the order sheet ST will be described below.

(C1) Form of Second Order Sheet:

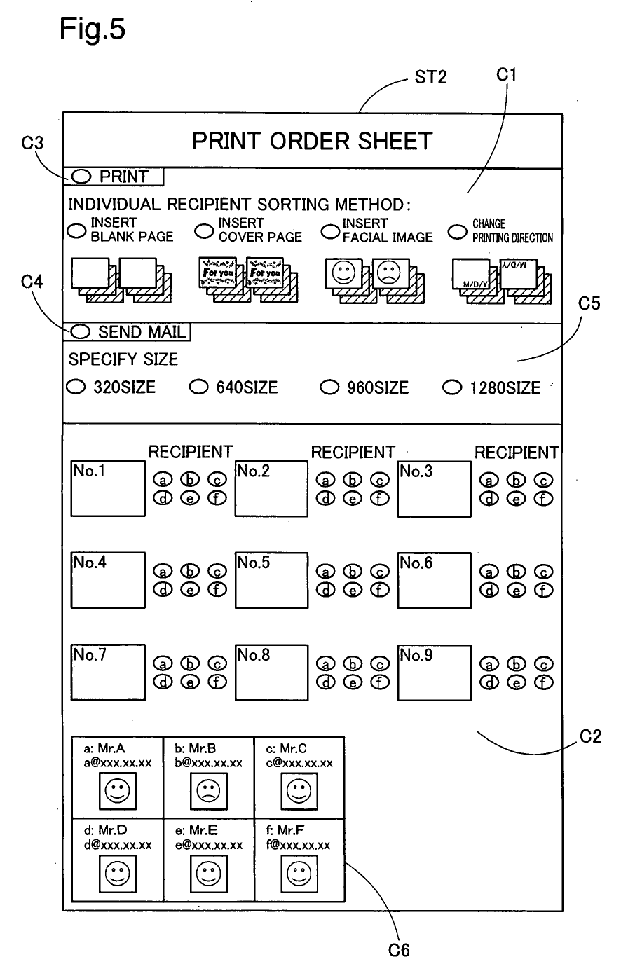

FIG. 5 is an illustration depicting the form of a second order sheet ST2. On the order sheet ST2 depicted in FIG. 5 are printed a sorting method specification field C1 and a recipient specification field C2 similar to those of the order sheet ST depicted in FIG. 4; additionally, a print specification field C3, a send mail specification field C4, a size specification field CS, and a recipient information display field C6 are printed as well.

The recipient information display field C6 is a field in which is printed personal information data for the recipients ((a)-(f)) shown in the recipient specification field C2. This personal information data is data that has been stored in the flash memory 190, and includes recipient name, mail address, and facial image data. The user can readily identify recipients by referring to this recipient information display field C6.

The print specification field C3 and the send mail specification field C4 are fields provided for selecting either printing of the image data specified in the recipient specification field C2, or sending the image data as an e-mail attachment. In the event that the user has marked the print specification field C3, the image data for the recipients specified in the recipient specification field C2 will be printed on the basis of the sorting method specified in the sorting method specification field C1, in the same manner as in the preceding embodiment. On the other hand, where the send mail specification field C4 has been marked, e-mails with the image data attached will be sent to the mail addresses of the recipients specified in the recipient specification field C2, via the network interface 135. Sending of e-mails is executed in place of Step S150 and Step S160 in the individual recipient printing process discussed previously. Where both the print specification field C3 and send mail specification field C4 have been selected, the images will be both printed and sent by e-mail. Of course, instead, an error message could be displayed on the liquid crystal monitor 145 in the event that both were selected.

The size specification field CS is a field provided for adjusting the size of image data, when image data is being sent as an e-mail attachment. This size specification field CS allows any of four size levels, i.e. 320 size, 640 size, 960 size, and 1280 size, to be specified. The numerical value of each size represents the pixel count of the long side of the image data subsequent to size adjustment. The user can adjust the size of the image data by filling in the marking field located to the left side of each size, using a writing implement. If none of the marking fields have been filled in, size adjustment of the image data will not be performed. It would also be possible to change the size of the image data to the default size (e.g. 1024 size) in the event that none of the marking fields have been filled in.

In the sorting method specification field C1 shown in FIG. 5, in addition to the sorting methods shown in FIG. 4, it is possible to specify the sorting method “insert a facial image.” Where this sorting method has been specified, in Step S160 of the individual recipient printing process, the printing device 100 will read facial image data from the personal information data stored in the flash memory 190 and print this facial image data in accordance with the recipients specified in the recipient specification field C2. It is possible thereby to easily identify the recipients to which the printed image data has been sorted. While the example given here involves printing facial images, it would also be acceptable to print recipient names, mail addresses, and so on, instead of or in addition to facial images.

In the order sheet ST2 depicted in FIG. 5, using the print specification field C3 and the send mail specification field C4, it is possible to select on the order sheet whether to print images or send them as e-mail attachments. Alternatively, it is possible for this selection to be made from the GUI displayed on the liquid crystal monitor 145. This would make it possible to simplify the design of the order sheet ST2.

(C2) Form of Third Order Sheet:

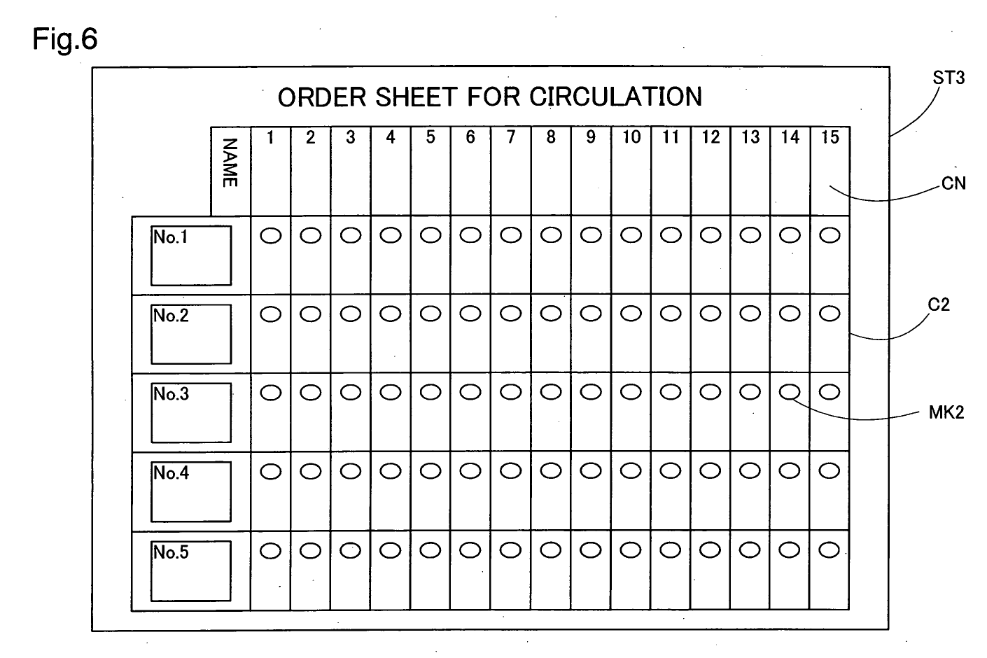

FIG. 6 is an illustration depicting the form of a third order sheet ST3. This order sheet ST3 is used primarily for taking image print orders from a large number of individuals. In the example depicted in FIG. 6, the recipient specification field C2 is designed in matrix form allowing up to 15 recipients to be specified for each set of image data. Individuals to whom this order sheet ST3 is circulated will enter their names in the name entry field CN, and using a writing implement, mark the marking fields MK2 which correspond to the image data desired. The number of individuals that it is possible to specify as recipients is arbitrary.

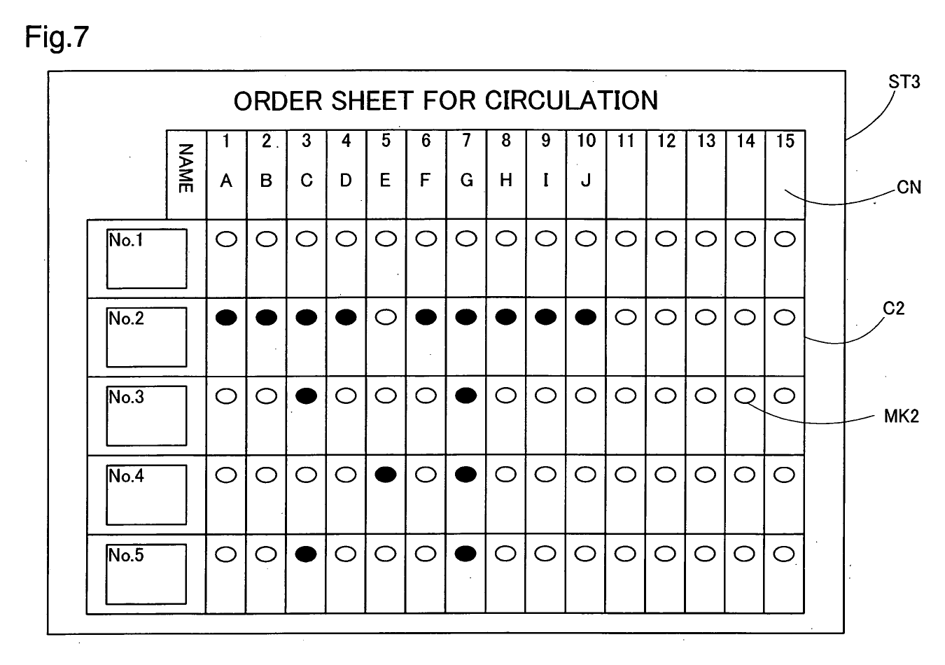

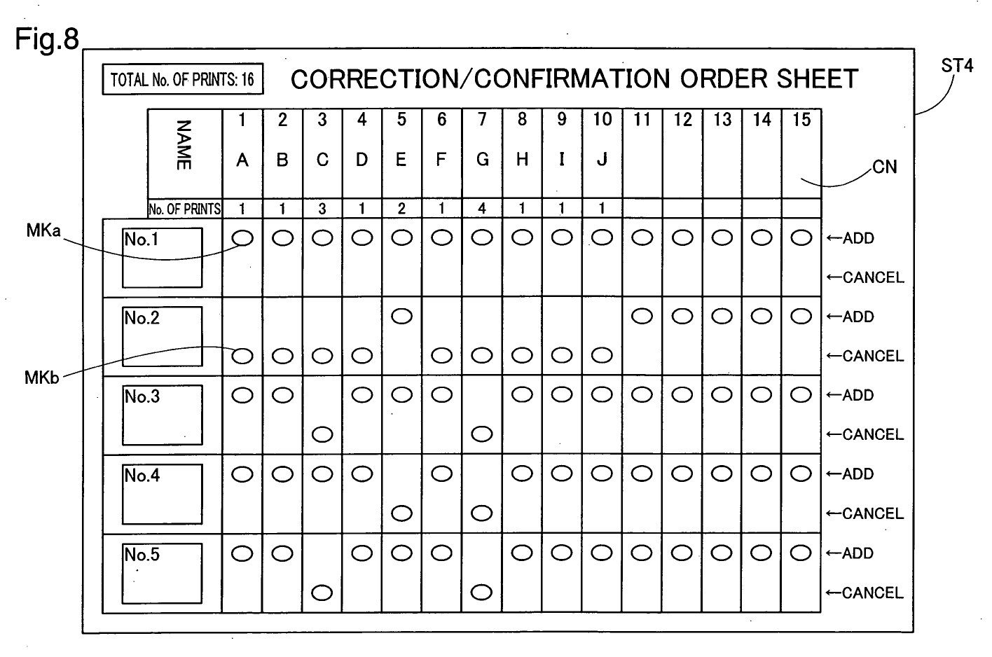

FIG. 7 is an illustration depicting an example of filling in the third order sheet ST3. This drawing shows an example in which the order sheet ST3 has been circulated among individuals “A” to “J,” who have entered their names in the name entry field CN and marked their desired images. When this order sheet ST3 is scanned by the scanner 110, the printing device 100 will perform printing of the image data specified for each individual recipient. Here, it is assumed that the printing device 100 will print the image data for individual recipients by the default sorting method (e.g. inserting a blank sheet). Of course, it would also be possible to provide the order sheet ST3 with a sorting method specification field C1 like that in FIG. 4, to enable the sorting method to be specified.

Where the order sheet ST3 depicted in FIGS. 6 and 7 is employed, it would be possible to also print the confirmation/correction order sheet (hereinafter referred to as “c/c order sheet”) ST4 shown in FIG. 8, for correcting an order received using this order sheet ST3. After the order sheet ST3 has been scanned in Step S130 of the individual recipient printing process described above, the image data for each individual recipient is tallied in Step S140, and the result thereof is reflected in this the c/c order sheet ST4; the c/c order sheet ST4 is then printed before proceeding to the process of Step S150.

FIG. 8 is an illustration depicting an example of the c/c order sheet ST4. The handwritten names that were entered into the order sheet ST3 and subsequently scanned by the scanner 110 have been copied and printed into the name entry field CN of this confirmation/correction order sheet ST4. Below the name entry field CN are printed the number of prints of image data ordered by each individual. The total number of prints of image data ordered with the order sheet ST3 is printed at upper left.

In the c/c order sheet ST4 there are also printed Cancel marking fields MKa for canceling image data that was ordered with the order sheet ST3, and Add marking fields Mkb for ordering additional image data not ordered previously. The Cancel marking fields MKa are provided for those sets of image data that were ordered with the order sheet ST3; the Add marking fields Mkb are provided for those sets of image data that were not ordered with the order sheet ST3. Using these marking fields, individuals to whom the c/c order sheet ST4 is circulated can easily cancel or add orders.

The name entry field CN of the c/c order sheet ST4 shown in FIG. 8 includes fields with no names entered in them (the fields labeled “11” to “15”). It is therefore possible, using these fields to take additional orders from individuals who did not previously place an order by means of the order sheet ST3. In addition to the various fields described above, the c/c order sheet ST4 may also have printed thereon billed amounts for the number of prints ordered by each individual.

When subsequent to Step S140 of the individual recipient printing process and prior to Step S150, the printing device 100 scans the completed confirmation/correction order sheet ST4 by means of the scanner 110, the ordered data is again tallied and sorted. In the process starting with Step S150, the image data for each recipient is printed. By employing the order sheet ST3 and the c/c order sheet ST4 depicted in FIGS. 6 to 8, it is possible to take orders for image data printouts from a large number of individuals, and to easily print the image data for each individual recipient.

D. Modifications:

While the invention has been shown hereinabove in terms of a certain preferred embodiment, the invention is not limited to the embodiments herein and may assume various other arrangements without departing from the spirit thereof. For example, functions accomplished by software could instead by accomplished by hardware. In addition, the following modifications are possible.

(D1) Modification 1:

In the preceding embodiment, it was presumed that the printing device 100 prints on one side only. On the other hand, where the printing device 100 is furnished with duplex printing functionality, it would be possible to print the recipient's name, mail address, facial image or other personal information data on the reverse side of the paper, without inserting a set-off sheet such as a blank or cover sheet. Additionally, the printing face may be changed for individual recipients. Even in the case of one-sided printing, personal information data may be printing in a blank area of the printing face.

(D2) Modification 2:

The printing device 100 may be provided with a function of analyzing the image data input from the memory card MC etc., and detecting human faces appearing in the image data. In this case, the printing device 100 would carry out on each set of image data input from the memory card MC etc., a face detection process for detecting faces. For an individual whose face was detected, it could then be determined to distribute the particular image data to that individual. Subsequent to this decision, the printing device 100 would then tally the image data for distribution for each detected face, and print image data for each of these individuals. By means of such a process, the printing device 100 would be able to set up recipients automatically with reference to faces detected in the image data, making it possible for printing for individual recipients to be carried out without the use of an order sheet. In this case, the results of automatic setting of recipients could be output to the c/c order sheet ST4. This makes possible some flexibility in correcting automatic setting of recipients by means of face detection.

(D3) Modification 3:

The printing device 100 may also store in the flash memory 190 an image data printing record for each individual recipient. By referring to these printing records, the printing device 100 could display a warning to the liquid crystal monitor 145 in the event that image data specified by means of the order sheet ST has already been printed for the intended recipient. By so doing, it is possible to prevent duplicate printing of image data for a given recipient. Also, by referring to these printing records, the printing device 100 may create an order sheet ST omitting the marking fields MK2 for specifying image data that has already been printed. In this way as well, it is possible to prevent duplicate printing of image data for a given recipient.

(D4) Modification 4:

In the preceding embodiment, input of image data, printing and scanning of the order sheet ST, and printing of image data for individual recipients are performed by the printing device 100 alone. Alternatively, however, it would also be possible to connect the printing device 100 to a computer and to execute a process similar to the individual recipient printing process discussed above, by means of installing a prescribed program on the computer. In this case, the computer would perform input of the image data, and the printing device 100 would print the order sheet ST. The filled-in order sheet ST would then be scanned by the scanner 110 provided in the printing device 100, is and the image data printed for the specified individual recipients. In this arrangement, the system composed of the printing device 100 and the computer is equivalent to the printing device herein. This arrangement could also be configured with the scanner and printing device as separate devices.

(D5) Modification 5:

In the individual recipient printing process described in the preceding embodiment, all of the image data input from the memory card MC etc. was printed out in the order sheet. Alternatively, however, it would be possible to not print out on the order sheet any image data in which camera shake, blurring, or improper exposure has occurred. Such images are most probably images that were shot improperly, and in most instances should not be distributed. Likewise, images containing no human subjects should not be distributed in most instances, and as such need not be printed on the order sheet. Detection of shake, blurring, or improper exposure, and detection of human subjects, may be accomplished using known image processing technologies.

(D6) Modification 6:

The preceding embodiment described filling in the marking fields for the recipients designated “a,” “b” and so on when specifying recipients on the order sheet (see FIG. 4, for example). Alternatively, however, it would be possible for the user to enter by hand the designations of recipients “a,” “b,” and so on directly, in a prescribed entry field provided on the order sheet. In this case, the handwritten text would be recognized using known OCR technology, and printing of image data would be carried out for each of the specified recipients.

E. Other Aspects:

It is possible for the present invention to be reduced to practice in the following aspects. The differentiatable elements mentioned previously can represent different recipients. Alternatively, the differentiatable elements can represent different print destinations, output destinations, presentation destinations, delivery destinations, or the like.

In the printing device described above, the image data printing unit may be provided with a unit for changing the printing direction of the image data when printing the image data corresponding to the different marked elements. With such an arrangement it is possible to change the printing direction for individual elements, thus making it easy to distinguish separators between elements, even where image data is printed continuously.

In the printing device described above, the image data printing unit may be provided with a combining unit for combining the shooting date of the image data with the image data; and when the printing direction of the image data is changed, the image data printing unit may settle the printing direction of the shooting date according to the printing direction of the image data. With such an arrangement, the direction of the shooting date printed together with the image will be changed as well, whereby is possible to easily distinguish that the printing direction has changed for individual elements during printing.

In the printing device described above, the image data printing unit may output a prescribed printing medium for each of the grouped image data. As the prescribed printing medium, a blank page or page displaying a prescribed image could be output, for example. With such an arrangement, printing can be carried out while inserting a blank page or printing page displaying a prescribed image, each time that image data corresponding to a different element is printed out, thus making it easy to distinguish separators between elements, even where image data is printed continuously.

In the printing device described above, there may be provided a memory unit for storing individual information for each element; and the image data printing unit may output a page having the individual information for the individual elements printed thereon, as the prescribed printing medium mentioned previously. In this case, at least one item selected from the name, mail address, and facial image of each element may be stored in the memory unit as the individual information for each element. With such an arrangement, a sheet having individual information such as the name, mail address, or facial image of the element printed thereon can be output each time that image data corresponding to a different element is printed out, thus making it easy to distinguish separators between elements, even where image data is printed continuously.

In the printing device described above, the order sheet printing unit may print on the order sheet a sorting specification field for the purpose of specifying a mode of sorting the image data for each element; and depending on the mode specified in the sorting specification field, the image data printing unit may print the image data for each marked element. In this case, for example, the order sheet printing unit may print, as the sorting specification field, a field enabling specification of either a mode of outputting a prescribed printing page or a mode of changing the printing direction, when printing image data corresponding to different elements.

With such an arrangement, the mode of sort to be used when grouping and printing image data for each element can be selected at will using the order sheet. User convenience can be improved thereby.

In the printing device described above, the order sheet printing unit may prints a correction order sheet having laid out thereon marking fields for the purpose of correcting the elements of individual sets of image data specified by means of the order sheet, after the scanning unit has initially scanned the order sheet; and the analyzing unit may correct the results of the analysis of the order sheet, according to the results marked on the correction order sheet. With such an arrangement, by using this correction order sheet, the user is afforded some flexibility in correcting specification of elements of individual sets of image data.

The printing device described above may also be furnished with a unit for storing the mail address corresponding to each of the elements, and a unit for sending the image data specified for the element to the mail address associated with the element. With such an arrangement it is possible for image data specified on the order sheet to be sent by e-mail.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A printing device for printing image data, the printing device comprising:
an input unit that inputs multiple sets of image data;
an order sheet printing unit that prints an order sheet wherein there are laid out a list of the input image data, and a marking field having differentiatable elements for each individual set of the image data;
a scanning unit that scans the order sheet;
an analyzing unit that analyzes the scanned order sheet and specifies the elements marked by the marking fields; and
an image data printing unit that groups and prints the image data for each of the marked elements, on the basis of the is results of the analysis of the scanned order sheet.

2. The printing device according to claim 1, wherein
the differentiatable elements are different recipients.

3. The printing device according to claim 1, wherein
the image data printing unit changes the printing direction of the image data when printing the image data corresponding to the different marked elements.

4. The printing device according to claim 3, further comprising:
a combining unit for combining the shooting date of the image data with the image data; and
wherein the image data printing unit, when changing the printing direction of the image data, settles the printing direction of the shooting date according to the printing direction of the image data.

5. The printing device according to claim 1, wherein
the image data printing unit outputs a prescribed printing medium for each of the grouped image data.

6. The printing device according to claim 5, wherein
the image data printing unit outputs a blank page or a page displaying a prescribed image as the prescribed printing medium.

7. The printing device according to claim 5, further comprising:
a memory unit that stores individual information for the individual elements;
wherein the image data printing unit, as the prescribed printing medium, outputs a page having the individual information for the individual elements printed thereon.

8. The printing device according to claim 7, wherein
the memory unit stores as the individual information for each of the elements at least one item of information selected from the name, mail address, and facial image of the element.

9. The printing device according to claim 1, wherein
the order sheet printing unit prints on the order sheet a sorting specification field for specifying a mode of sorting the image data for the individual elements; and
the image data printing unit prints the image data depending on the mode specified in the sorting specification field for each marked element.

10. The printing device according to claim 9, wherein
the order sheet printing unit prints as the sorting specification field a field enabling specification of either a mode of outputting a prescribed printing medium or a mode of changing the printing direction, when printing the image data corresponding to the different marked elements.

11. The printing device according to claim 1, wherein
the order sheet printing unit prints a correction order sheet having laid out thereon marking fields for correcting the elements specified by the order sheet, after the scanning unit has scanned the order sheet;
the analyzing unit corrects the results of the analysis of the order sheet, according to the results marked on the correction order sheet.

12. The printing device according to claim 1, further comprising:
a unit for storing the mail address corresponding to each of the elements; and
a unit for sending the image data specified for the element to the mail address associated with the element.

13. A printing method for printing image data by a printing device equipped with a scanner, the printing method comprising:
inputting multiple sets of image data;
printing an order sheet wherein there are laid out a list of the input image data, and a marking field having differentiatable elements for each individual set of the image data;
scanning the order sheet;
analyzing the scanned order sheet and specifying the elements marked by the marking fields; and
grouping and printing the image data for each of the marked elements, on the basis of the results of the analysis of the scanned order sheet.

14. A computer program product for printing image data by a computer having a printing device and scanner connected thereto, the computer program product comprising:
a computer readable medium; and
a computer program stored on the computer readable medium, the computer program causing a computer to implement the functions of:
inputting multiple sets of image data;
printing an order sheet wherein there are laid out a list of the input image data, and a marking field having two or more differentiatable elements for each individual set of the image data;
scanning the order sheet;
analyzing the scanned order sheet and specifying the elements marked by the marking fields; and
grouping and printing the image data for each of the marked elements, on the basis of the results of the analysis of the scanned order sheet.
